(19) United States
(12) Patent Application Publication
(10) Pub. No.: US 2016/0048909 A1
(43) Pub. Date: Feb. 18, 2016

(54) Landlord Financial Recovery Bureau

(71) Applicant: Melvin Barnes, Chicago, IL (US)

(72) Inventor: Melvin Barnes, Chicago, IL (US)

(21) Appl. No.: 14/461,396

(22) Filed: Aug. 16, 2014

(51) Int. Cl. G06Q 30/06; G06Q 50/16; G06Q 50/18

(52) U.S. Cl. CPC G06Q 30/0645; G06Q 50/188; G06Q 50/163; G06Q 50/182

(57) ABSTRACT

Disclosed is a system for a landlord to negotiate with a tenant, including the steps of at least one tenant and one landlord entering into a lease agreement that obligates the tenant to provide identifying information, sign a waiver and entering all of the aforementioned information into a database, a landlord financial recovery bureau requesting on behalf of the tenant that the landlord executes an agreement and collecting factual information about the tenant for a tenant occupancy report. The tenant occupancy report being used to develop a tenant fact report summarizing details related to the tenant's occupancy of the rental property and being annotated to reflect verified documents in a tenant evidence locker. Any tenant or client request for information or submission of information being administered online through submission of forms to a central database or manually by a landlord financial recovery bureau.

### FIELD OF THE INVENTION

This application relates generally to rental property information and more particularly to the collection of rental property data to support the informational needs, conflict resolution and financial recovery of landlords, management services and tenants.

Currently there are millions of vacant and abandoned properties in cities throughout the United States. This affects the social health of a community, quality of life and the general physical well being of individuals.

The rate of housing development or decline can also affect the rate of job development in residential construction, non-residential construction and engineering. Other sectors are also negatively influenced by the decline in the construction industry. There can be a marked decline of jobs in the manufacturing sector, wood product production, retail trade, architecture and private services.

Neighborhoods, communities and schools are the social institutions that tie people together and promote social progress. The cost of housing is the greatest single expenditure for families and individuals. In particular, low-income individuals often spend as much as 60% or more of their income on housing. Often times, the funds are spent on low quality and unsafe housing.

The rapid urbanization of most American cities also necessitates the improvement of housing for poor and working class families. This involves ensuring that most people can find affordable and quality housing where they work, go to school or raise their families.

There are numerous types of softwares being marketed to provide tenant screening and tenant risk information. Most of these products use consumer reports that include information about a person's credit characteristics, lifestyle and general reputation. For example, the Landlord Protection Agency provides risk information about a tenant by providing the landlord's public records, eviction files and other information about a tenant's lifestyle. The agency stores this information in a database and invites landlords and other interested parties to input information into the database. However, the Landlord Protection Agency does not verify the source of the information and does not assist landlords or tenants in resolving disputes. Also, instead of assisting with the actual recovery of funds, the agency encourages landlords to report tenants to credit bureaus or to tenant reporting databases. The tenant information is simply collected in a database and the landlord has to await recovery from a collection agency. This method of collecting unverified tenant information might lead to housing discrimination. The external sources can exploit the tenants that they perceive to be unfavorable or bad tenants.

Most, if not all, landlords want to know considerable information about a tenant who expresses an interest in renting property. A landlord with a significant number of rental properties might find public verifiable information difficult to compile. Often times, the information is untrue or inadequate. The landlord might also have to expend a considerable amount of time to investigate a client's rental history or relevant information is often scattered, outdated or incorrect. The landlord's due diligence and the tenant's ability to comply with a landlord's demands can become an expensive and time-consuming process.

The landlord financial recovery bureau (hereinafter bureau) of the present invention is more factual or evidentiary than the prior art. Landlords and management services agree to a full disclosure of the terms of a lease and numerous facts and evidentiary information relating to the lease of a specific property. Landlords are required to complete an occupancy report for each tenant. The tenant occupancy is the initial documentation evidencing the existence of a lease agreement between the landlord and the tenant. It includes specific tenant identifying information regarding the lease. The tenant identifying information can include a photo of the tenant, the tenant's name, current address, race and physical description. The occupancy report is used to develop a tenant profile, which is referred to as a tenant fact report.

A tenant fact report is a more developed profile of the tenant, which provides the physical description of a tenant, background information, credit history, and any criminal history. The tenant fact report is used to create a tenant evidence locker, which is managed and updated by the bureau. The tenant evidence locker can include notes documenting previous discussions between the landlord and tenant, summons, lease citations, decrees, judgments and police reports. The bureau verifies any information stored in a tenant evidence locker and the bureau can request on behalf of the tenant proof of a particular incident.

The verification process requires the bureau to perform specific verification proceedings including researching case summaries from courts, finding a case using a disclosed case number, a tenant's name or the name of any business associated with a tenant. The bureau can also make direct contact or consult with a particular court or police officer. In some cases, the tenant evidence locker can be verified with public information. The afore-mentioned methods of verification by the bureau would guarantee that the information provided is accurate, is in the most current form and that the identity of the tenant whose name appears on the report is accurate.

All information collected from the landlords and tenants are analyzed and stored in a database. The database is updated with new client or landlord information within 24 hours of the bureau receiving notice of the update. The tenant fact report would provide notations summarizing the fact of a particular update. The supporting documentation would be verified as mentioned above and stored in the tenant evidence locker.

The bureau protects the privacy of the tenant and provides guarantees that the information provided by the landlord is accurate. When a prospective client has knowledge that a landlord may create a negative or positive profile in a database, the tenant is more likely to pay rent.

All information stored in the database can be used as supportive evidence to confirm any negative reports from the landlord. This is another method of verifying all landlords' reports of incidences attributed to a particular tenant. Retaining a database of tenant evidence lockers and tenant fact reports also saves time in the negotiation process. A negotiator can simply review a summary of specific transactions that occurred between the landlord, their tenant and the bureau. The negotiation process might also be necessary to avoid disputes between the landlord and tenant and to avoid using the court system for certain processes like eviction.

This inventive concept will put value back into housing and increase spending by allowing landlords to sign a verification agreement, confirm rental property ownership and complete a detailed disclosure of the past condition of the property. This can include information related to previous damage to the property.

The financial recovery bureau is also designed to benefit good landlords and good tenants. If a tenant is aware that a citation or police report would enter the tenant's evidence locker, the tenant is less likely to incur a citation or commit an act that is contrary to his or her real property interest. Tenants are less likely to abide by lease terms if there is a high supply of apartments and the details of the tenant's occupancy are not tracked or recorded. The system of the present invention would undercut that situation by retaining a tenant evidence locker that serves as a track record and evidence against the tenant. The chances for the tenant to find an alternative property might be lowered if there is a track record that the landlord can refer to. If there is a lower supply of apartments available but there are enough tenants who are interested in renting then the landlords can request a higher rental price. The tenants, having an interest in renting the property, would be willing to pay more because there are no alternatives.

There are thousands of cases in the court system. Some landlord tenant cases can take months to resolve. The bureau attempts to resolve conflicts between landlords and tenants by assigning a negotiator to resolve disputes. The negotiator accesses the database and retrieves information related to any offers and counter offers by the landlord or the client. The landlord verification agreement recommends that all registered landlords work with the financial proceedings of the bureau or risk losing their membership.

The negotiator can procure payments and can provide expert advice in landlord tenant matters. For example, the tenant might not understand his or her rights against the landlord. The Negotiator can help make informed decisions and have control over the legal process, help both parties understand their rights and obligations in order to better protect themselves and their assets. The landlord can later choose to accept offers, counteroffers or release a tenant from liability. This negotiation process can also prevent retaliation from either party and encourages both parties to settle a case.

This inventive concept provides landlord with facts about a client that are sufficient to deny that person a lease. For example, the landlord financial recovery database provides continuous information about previous landlords and previous disputes about back-rent and unpaid property damages. The public availability of negative rental histories would put more pressure on the tenant to resolve all financial matters related to a particular property interest. The ultimate decision would be based on the landlord's risk tolerance. For example a tenant owing two months rent might not be more of a financial risk; it is based on the financial risk level of the landlord. This concept places the tenant evidence locker at the landlord's disposal for analysis and for review of the tenant's rental history as a financial risk.

### BRIEF DESCRIPTION OF THE SEVERAL VIEWS OF THE DRAWINGS

The foregoing features and other aspects of the invention will become more apparent from the description, taken together with the accompanying drawings, in which:

FIG. 1 is a flowchart showing the preferred embodiment of the system for collecting rental property data to support the informational needs of landlords, management services and tenants.

FIG. 2. shows the details of the landlord's enrollment process.

FIG. 3 is an exemplary form showing the landlord financial recovery bureau's member verification agreement requesting a landlord's background information and requiring landlords to complete a background, credit check and title check.

FIG. 4 is an exemplary form providing the rental property ownership of a landlord showing the address, tax identification and other identifying information for the rental property.

FIG. 5 an exemplary form showing the preliminary information that would be placed in a tenant occupancy report including lease information, address of the rental property and tenant identifying information.

FIG. 6 is an exemplary form showing updates that would be placed in a tenant fact report including rent increase and the name of the management service that made the update.

FIG. 7 is an exemplary tenant fact report as provided by the present invention.

FIG. 8 is a flow chart showing the process which tenants select landlord and verify details in an occupancy report.

FIG. 9 is an example of a tenant's evidence locker as provided by the present invention.

FIG. 10 is a block diagram of a computer network system used to host and access the bureau's secured website.

FIG. 11 shows a sample webpage through which the landlords, management services and tenants can contact the bureau and complete a plurality of forms.

FIG. 12 is a flow chart that describes the negotiation process and showing the steps necessary to accept tenant or landlord offers and counteroffers.

FIG. 13 shows the steps necessary to create a member verification agreement.

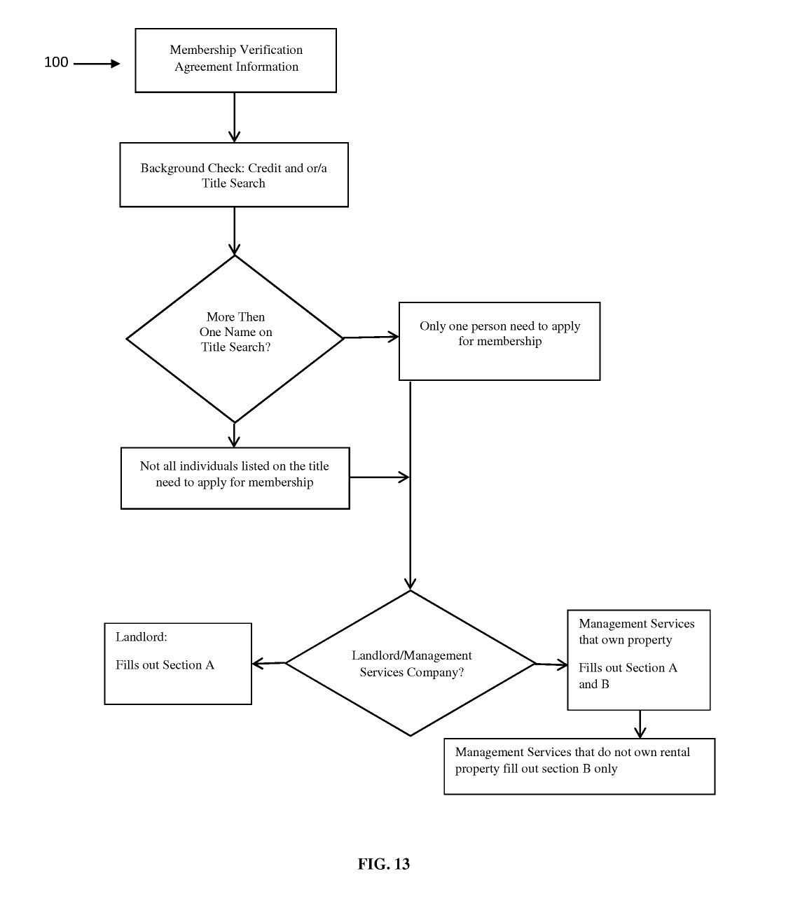

### DETAILED DESCRIPTION OF THE INVENTION

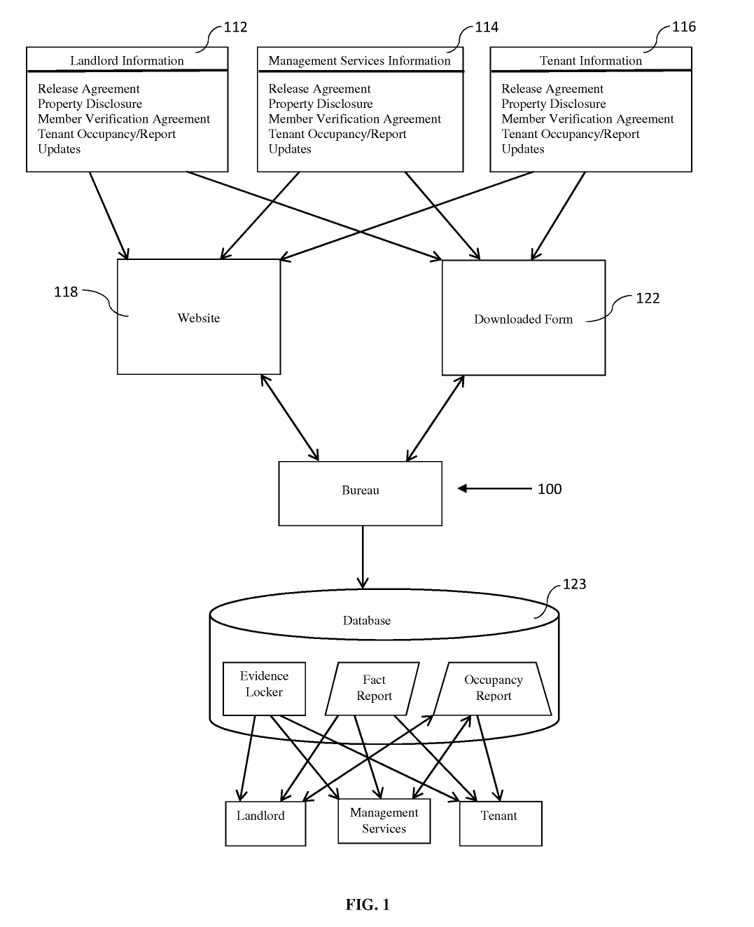

FIG. 1 is a flowchart showing the preferred embodiment of the system for collecting rental property data to support the informational needs of landlords, management services and tenants. A landlord financial recovery bureau (hereinafter bureau) 100 manages landlord information 112, management service 114 information and tenant information 116 and stores the information in a database 123. The landlords, management services and tenants can input the information into a database using a secured website 118 or sending downloaded forms 122 to the bureau 100. The landlord information 112 comprising a signed release agreement, a property disclosure form requiring the landlord to verify ownership of at least one rental property, a member verification 124 agreement requesting that the landlord agree to a background check and title search of the landlord's real property holdings. The landlord information 112 also includes a tenant occupancy report disclosing specific tenant identifying information regarding a lease and additional tenant information 116. The tenant information 116 can include a photo of the tenant, the tenant's name, current address, race, and physical description. The tenant information 116 comprises a signed tenant waiver which gives the landlord access to the tenant occupancy report.

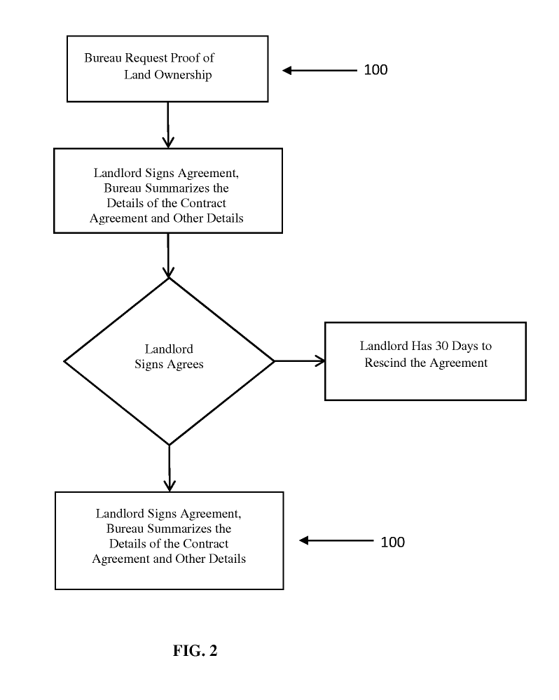

FIG. 2. shows the details of the landlord's enrollment process. This includes proof of real property ownership as previously discussed. The landlord can have thirty days to rescind any membership agreement. Any information and contract documents that are submitted to the bureau 100 is entered into the database 123.

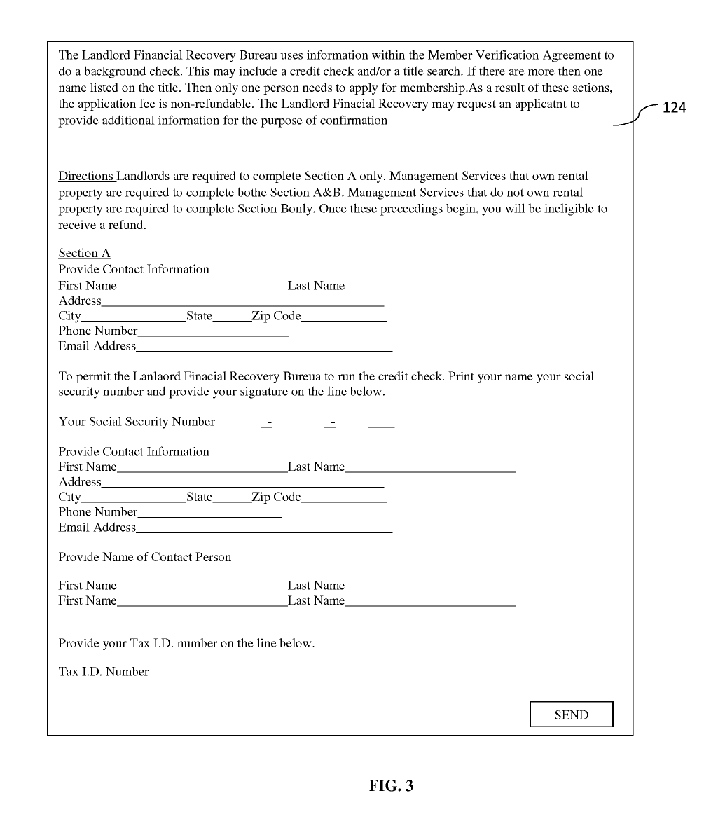

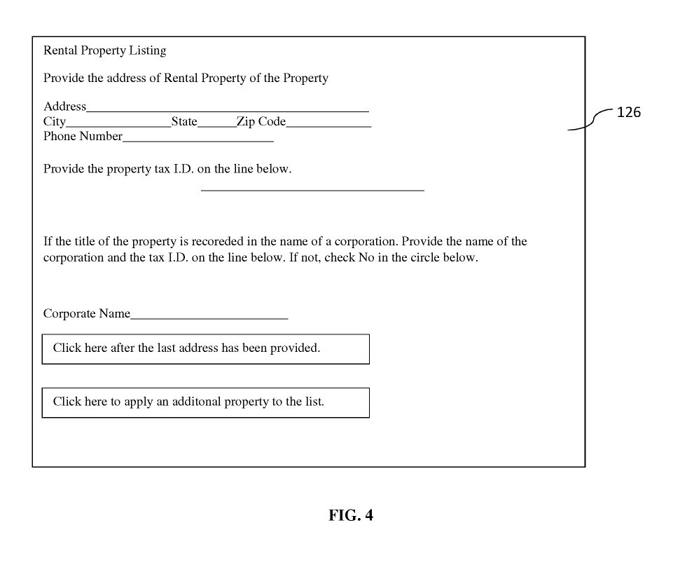

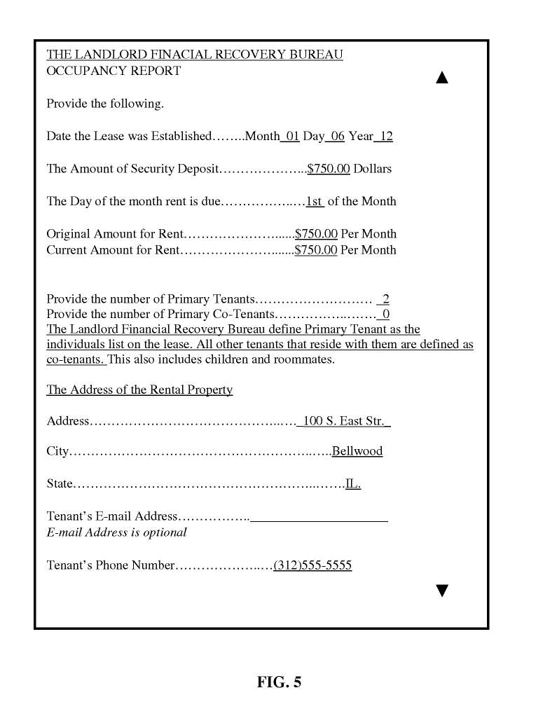

FIG. 3, FIG. 4 and FIG. 5 show the necessary forms that a landlord must complete before becoming a member of the bureau 100. The member's verification agreement 124 requires a landlord to agree to a background check. This could include a credit check or a title search. During the enrollment process, landlords are required to provide proof of landlord ownership by completing a rental property listing 126 verifying the rental property ownership of the landlord. The rental property listing 126 shows the address, tax identification and other identifying information for the rental property.

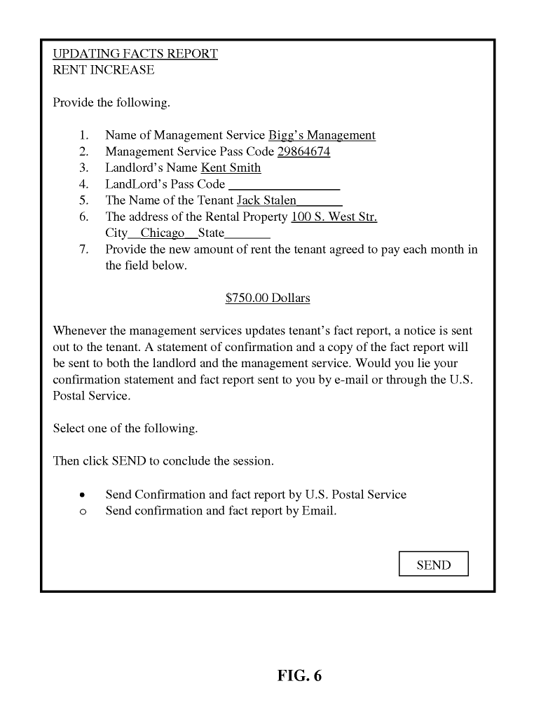

FIG. 6 shows the further development of a tenant's information 116. Besides the preliminary information about a client, a landlord is required to submit all tenant updates to the bureau 100. This information can include changes to the lease information, address changes and changes to the tenant's identifying information.

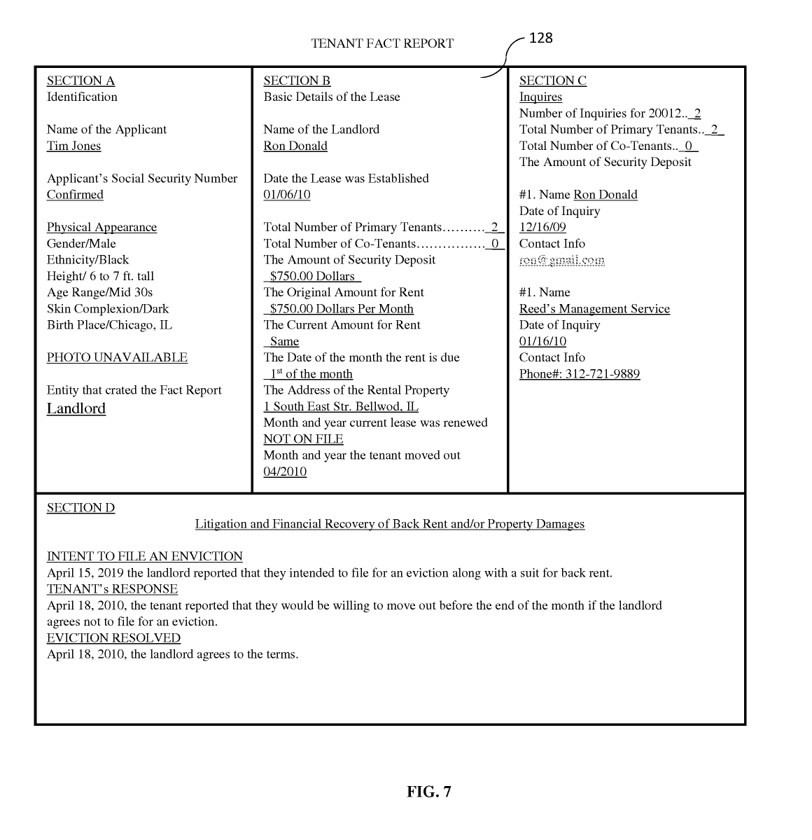

FIG. 7 is an exemplary tenant fact report 128 showing the tenant's information 116 including the tenant's name, address and other tenant identifying information. Updates can be placed in a tenant fact report 128. As previously mentioned, these updates can reflect rent increase and the name of the management service or landlord that made the update. This example of the tenant fact report 128 shows the tenant information being placed into sections A, B, C and D. Each section showing the tenant formation 116 including basic details of the lease, number of inquiries with regards to the tenant and notations and summarizing the details all documents in the evidence report.

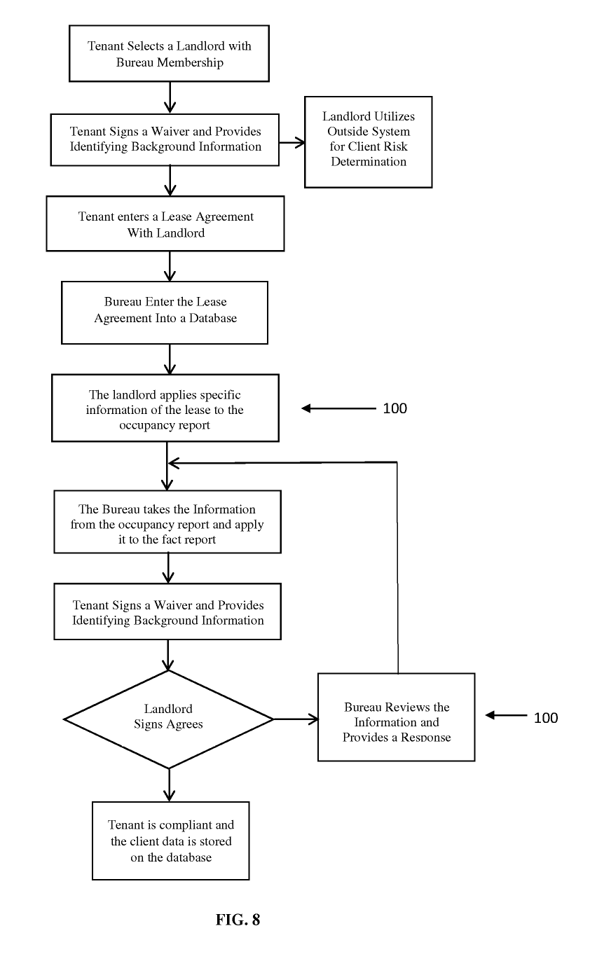

FIG. 8 is a flow chart showing the process by which tenants select landlords and verify details in an occupancy report. Tenants are required to select a landlord with a bureau 100 membership and sign a waiver giving landlords access to all of the landlord's background information. The landlord uses the tenant information to create a tenant occupancy report. The tenant occupancy report is stored in the secure database 205.

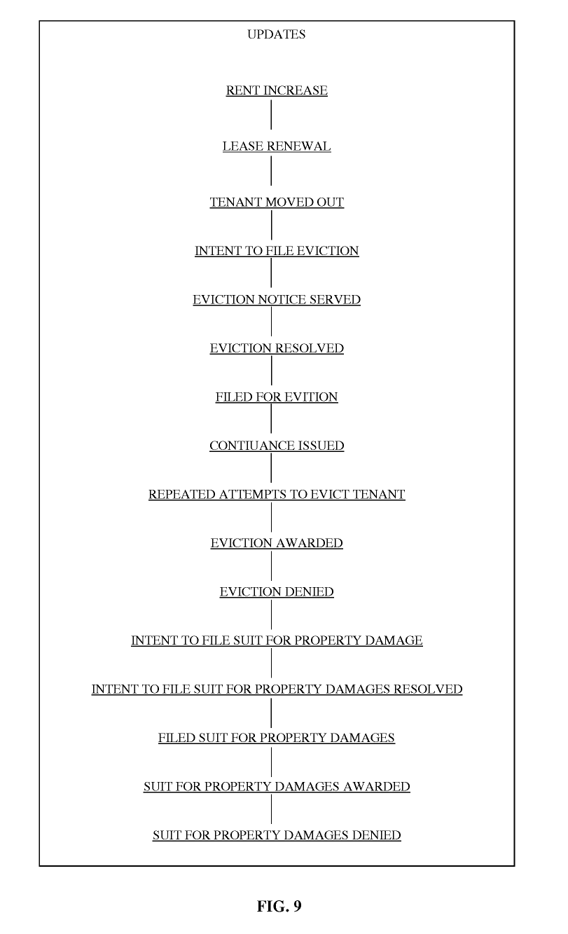

FIG. 9 is an example of a tenant's evidence locker 130. Notations and summaries in the tenant fact report 128 provide the fact of the existence of a tenant evidence locker 130. The bureau 100 creates the tenant evidence locker 130 after verifying the truthfulness of any updates and information submitted in a tenant fact report 128. The tenant evidence locker 130 can include notes documenting previous discussions between the landlord and tenant, summons, lease citations, decrees, judgments, police reports. The landlord, management service and tenant obtain access to the information stored in the tenant evidence locker 130 by requesting information from the bureau 100.

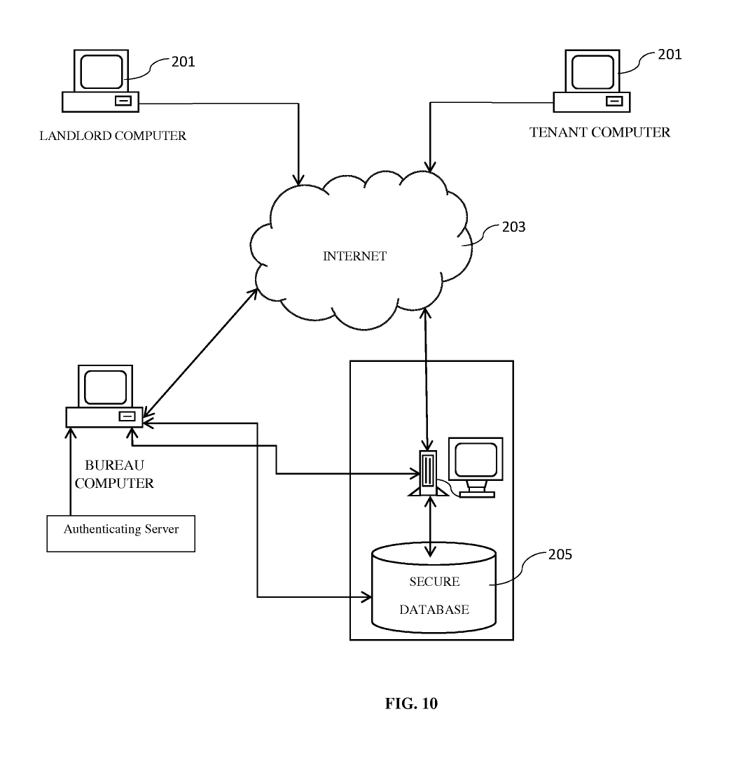

FIG. 10 is a block diagram of a computer network system used to host and access the bureau's 100 secured website 118. The secured website 118 is stored on an authenticating server 204. The bureau 100 grants access to the secured website 118 to the landlord or management service by way of at least one access code. The landlord and management service has limited access to the secured website 118 which consist of access to the tenant fact report 128. Requests for additional information can be submitted by phone or email. The secured website 118 containing a central database of forms. The secured website 118 can have information related to waivers, release agreements, member verification agreements, property disclosure and tenant occupancy reports. The completed forms are stored in the central database and organized in a plurality of information categories. The bureau 100 has access to the tenant information from the central database through a communication network that can include the secured website 118, internet, an intranet, an extranet or a telephone call.

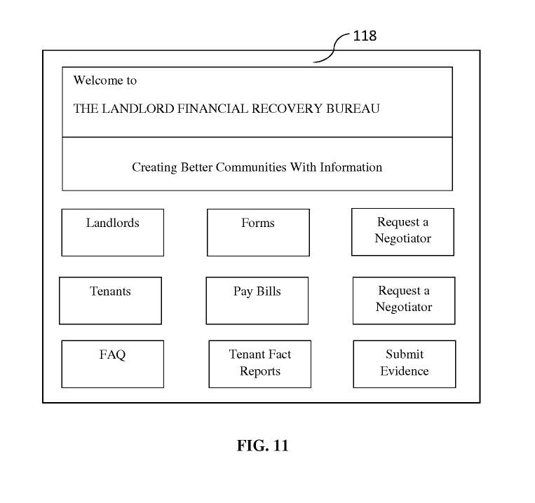

FIG. 11 shows a sample webpage 118 through which the bureau 100, landlords and tenants can contact the bureau 100 and complete a plurality of forms. For example, the landlord can complete a tenant fact report 128 by completing the form online and sending the information to the bureau 100. A negotiator can be requested if there is a court proceeding between the landlord and a tenant.

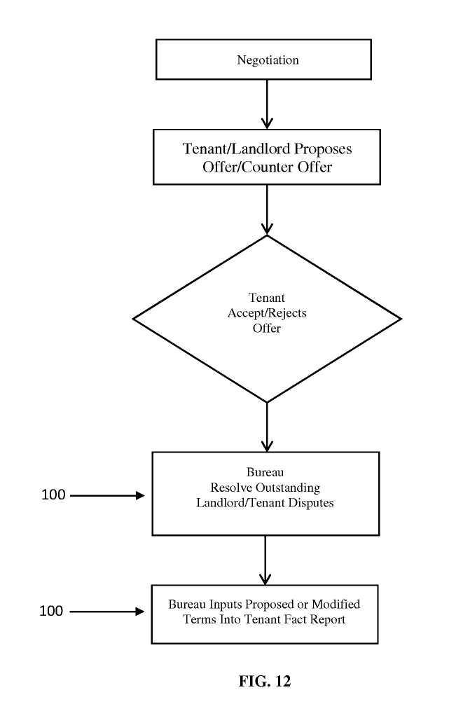

FIG. 12 is a flow chart that describes the negotiation process and showing the steps necessary to accept tenant or landlord offers and counteroffers. All negotiations between the landlord and the tenant become a part of the tenant fact report 128. The bureau 100 can assign a negotiator to disputes between the landlord and the tenant. The negotiator can negotiate a payment plan and institute collection proceedings for back-rent, money for property damages, rental capital or any additional fee that is associated with rental properties against said tenant. Any agreement created by the negotiator is included in the tenant fact report 128 as an update.

What is claimed is:

1. A system for collecting rental property data to support the informational needs, conflict resolution and financial recovery of landlords and tenants comprising:
a. a landlord financial recovery bureau (hereinafter bureau) managing landlords and tenants, said bureau inputting landlord information and tenant information into a database;
b. said landlord information comprising a signed release agreement, a property disclosure form wherein said landlord verifies ownership of at least one rental property, a member verification agreement requesting said landlord background information, said member verification agreement requesting a title search of said landlord's real property assets, said landlord's contact information, said landlord's identifying information, and a tenant occupancy report disclosing specific tenant identifying information regarding a lease, additional renters information, said tenant identifying information can include a photo of said tenant, said tenant's name, current address, race, and physical description;
c. wherein said landlord submitting said landlord information to said bureau entitles said landlord information to a term membership in said bureau;
d. said tenant information comprising a signed tenant waiver giving said landlord access to said tenant occupancy report, said tenant indicating to said bureau which landlord he or she prefers to receive said tenant occupancy report;
e. said landlord and said tenant obtaining access to said information in said tenant evidence locker by requesting information from said bureau;
f. said bureau creating said tenant fact report using the information from said tenant occupancy report, said tenant fact report containing said tenant identifying information, said landlord's name, specific details about the rental property, specific inquiries requested by said tenant and an outline summarizing the existence of any substantive evidence or documents in said tenant's tenant evidence locker, said tenant being notified of the creation of said tenant fact report pertaining to said tenant by said bureau;
g. said bureau creating said tenant evidence locker after verifying the truthfulness of said information in said fact report by checking court records, consulting with courts and checking police departments, said landlord providing said bureau inputting the fact of said updates into said fact report and supporting documentations into said evidence report, said supporting documentations comprising summons, lease citations, decrees, judgments and police reports, said client being notified of said facts in said fact report and said updates in said tenant evidence locker;
h. Wherein said bureau is adapted to update said tenant files to show work with management services; term updates, tenant occupancy reports, tenant fact reports, tenant evidence lockers, issuing access codes to landlord and management services and said access codes.

2. The system of claim 1 wherein said system can have a secured website, said secured website being stored on an authenticating server, said bureau granting access to said secured website to said landlord and giving at least one access code to said landlord for accessing the secure site, said access code having one or more restrictions from said bureau consisting of the tenant fact report, said secured website containing a central database of forms and information related to waivers, release agreements, member verification agreements, property disclosure, said tenant occupancy reports, said tenant fact reports and said tenant evidence lockers, said landlord and said tenant can access the central database and view one or more of said forms to input said tenant or said landlord information, said forms are stored in said central database and organized in a plurality of information categories, said secured website being adapted to receive said forms, said secured website can be used for said landlord or said tenant communication with said bureau, said internet server having an interface to receive information and to provide information to an online server, said secured website having second access means for said bureau to access said tenant information from said central database through a communication network, said communication network being adapted to allow said tenant information and said landlord information to be readily incorporated into said database and allowing said tenant and said landlord information to be changed and updated, said communication means being selected from the group consisting of the internet, an intranet, an extranet and providing information by telephone.

3. Wherein said landlord uses said access code to receive copies of said tenant fact report and to view said tenant fact report on said secured website.

4. The system of claim 1 wherein said bureau can assign a negotiator to disputes between said landlord and said tenant, wherein said negotiator can institute collection proceedings for back-rent, money for property damages, rental capital or any additional fee that is associated with rental properties against said tenant, wherein said negotiator can be assigned to any legal action instituted by said landlord, wherein said negotiator is used for past tenants who contact said bureau for the purpose of resolving payment of back rent and property damages, said negotiator can establish a payment plan for management by said bureau, wherein an agreement created by said negotiator is included in said tenant fact report as an update, said tenant being required to make said payment payable to said bureau, wherein said tenant fact report report is updated to show said payment by said tenant, said bureau remits said payment to said landlord, wherein said tenant can have said information expunged from said tenant fact report after said payment is received by said landlord.

5. The system of claim 1 wherein any information stored in said tenant evidence locker is verified by said bureau before said bureau inputs said information in said database in order to determine the accuracy of said information, said bureau verifying said information by researching case summaries from courts, finding cases using a disclosed case number or a tenant's name, consulting with police officers or using verified public information.

6. The system of claim 1 wherein said enrollment proceedings can be completed by the owner of a management service who whose main operation is the control and oversight of real property being rented by said tenant.

7. The system of claim 1 wherein said bureau can assist former landlords and former tenants.

8. The tenant fact report of claim 1 wherein said tenant can give a future landlord permission to access said tenant fact report, wherein said former landlord can provide supportive evidence in said tenant fact report.

9. The system of claim 1 wherein said tenants can request that said occupancy report, said tenant fact report and said tenant evidence locker in said database be expunged.

10. Wherein said landlord and said tenant cannot negotiate terms of any dispute between said landlord and said tenant without said negotiator.
